(19) United States
(12) Patent Application Publication
(10) Pub. No.: US 2014/0280118 A1
(43) Pub. Date: Sep. 18, 2014

(54) WEB SEARCH OPTIMIZATION METHOD, SYSTEM, AND APPARATUS

(71) Applicant: HON HAI PRECISION INDUSTRY CO., LTD., New Taipei (TW)

(72) Inventors: CHUNG-I LEE, New Taipei (TW); CHIEN-FA YEH, New Taipei (TW); YUE-CEN LIU, New Taipei (TW); GEN-CHI LU, New Taipei (TW)

(73) Assignee: HON HAI PRECISION INDUSTRY CO., LTD., New Taipei (TW)

(21) Appl. No.: 14/195,922

(22) Filed: Mar. 4, 2014

(30) Foreign Application Priority Data
Mar. 12, 2013 (TW) 102108612

(51) Int. Cl. G06F 17/30; G06K 9/00

(52) U.S. Cl. CPC G06F 17/3053; G06K 9/00288
USPC 707/732

(57) ABSTRACT

In a web search optimization method, a keyword is inputted by a user, and an image of the user is captured to identify facial feature data of the user. When there is facial feature data matched with the identified facial feature data in a storage device of the electronic device, reference parameters which corresponds to the identified facial feature data are obtained, and web pages in a searched result relating to the keyword are ranked according to the reference parameters.

### BACKGROUND

1. Technical Field

Embodiments of the present disclosure relate to query processing, and more specifically relates to techniques for optimized method of searching web pages.

2. Description of Related Art

People seek information from the Internet using a web browser. A person performs his/her search for information by pointing his/her web browser at a website associated with a search engine. The search engine allows a user to request web pages containing information related to one or more particular search words or phrases.

Although the search words and phrases may be used by the search engine to guide the search, finding target web pages being sought from hundreds or even thousands of web pages by users is challenging.

### BRIEF DESCRIPTION OF THE DRAWINGS

FIG. 1 is a schematic block diagram of one embodiment of a network environment for executing a web search optimization method.

FIG. 2 is a block diagram of first embodiment of a server that executes the web search optimization method.

FIG. 3 is a block diagram of second embodiment of a client that executes the web search optimization method.

FIG. 4 is a block diagram of one embodiment of function modules of a web search optimization system.

FIG. 5 illustrates a flowchart of one embodiment of a method of creating a user log.

FIG. 6 shows an example of a user log.

FIG. 7 illustrates a flowchart of one embodiment of the web search optimization method.

FIG. 8 illustrates a flowchart of detailing S16 in FIG. 7.

### DETAILED DESCRIPTION

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device.

FIG. 1 is a block diagram of one embodiment of a network environment for executing a web searching method. The network environment is constituted by a server 1 and a plurality of client devices 2 communicating with the server 1 through a network 3. The client devices 2 may be a computer, a smart phone, or a smart TV, for example. The network 3 may be the Internet or an intranet. Each of the client devices 2 includes a search engine which allows users to input keywords to query web pages containing information related to the keywords from the server 1. Furthermore, in the present embodiment, each of the client devices 2 includes a camera unit 20 for capturing images of users.

In a first embodiment, referring to FIG. 2, the server 1 is an apparatus that is installed with a web search optimization system 10 for executing the web search optimization method. The web search optimization system 10 includes a plurality of function modules (shown in FIG. 4), to realize functions of individually ranking web pages of a searching result related to a keyword inputted into the client device 2 by a user, according to reference parameters relating to facial feature data of the user, and transmitting the ranked web pages to the client device 2.

The server 1 further includes a control device 11 and a storage device 12. The control device 11 may be a processor, an application-specific integrated circuit (ASIC), or a field programmable gate array (FPGA), for example. The control device 11 may execute computerized codes of the function modules of the web search optimization system 10 to realize the functions of the web search optimization system 10. The storage device 12 may include some type(s) of non-transitory computer-readable storage medium, such as a hard disk drive, a compact disc, a digital video disc, or a tape drive. The storage device 12 stores the computerized codes of the function modules of the web search optimization system 10.

In a second embodiment, referring to FIG. 3, each of the client devices 2 is an apparatus that is installed with the web search optimization system 10 for executing the web search optimization method. The web search optimization system 10 includes the function modules (shown in FIG. 4), to realize functions of receiving a searching result related to a keyword inputted into the client device 2 by a user, individually ranking web pages of searching result according to reference parameters relating to facial feature data of the user, and outputting the ranked web pages.

Each of the client devices 2 further includes a control device 21 and a storage device 22. Similar to the control device 11, the control device 21 may also be a processor, an application-specific integrated circuit (ASIC), or a field programmable gate array (FPGA), for example. The control device 21 may execute computerized codes of the function modules of the web search optimization system 10 to realize the functions of the web search optimization system 10. The storage device 22 may also include some type(s) of non-transitory computer-readable storage medium, such as a hard disk drive, a compact disc, a digital video disc, or a tape drive. The storage device 22 stores the computerized codes of the function modules of the web search optimization system 10.

FIG. 4 is a block diagram of one embodiment of the function modules of the web search optimization system 10. The function modules includes a receiving module 100, an identification module 101, a creation module 102, an analysis module 103, a record module 104, a determination module 105, a rank module 106, an output module 107. The function modules may further include a classification module 108 and a collection module 109. The function modules 100-109 may include computerized codes in the form of one or more programs, which provide at least the functions needed to execute the steps illustrated in FIG. 5 to FIG. 8.

FIG. 5 illustrates a flowchart of one embodiment of a method of creating a user log. The method of creating a user log in FIG. 5 is executed when the web search optimization method is implemented using the web search optimization system 10 at the first time. The method is executed by at least one processor of an electronic device, for example, the control device 11 of the server 1 or the control device 12 of each of the client devices 2. Depending on the embodiment, additional steps in FIG. 5 may be added, others removed, and the ordering of the steps may be changed.

In step S01, the receiving module 100 receives a keyword inputted by a user from one of the client devices 2, and captures an image of the user. As mentioned above, each of the client devices 2 includes a search engine which allows the user to input the keyword to query web pages containing information related to the keyword from the server 1. In one embodiment, the receiving module 100 receives the keyword from the search engine of the client device 2. In one embodiment, the receiving module 100 activates the camera device 20 of the client device 2 automatically to capture the image of the user. In another embodiment, the receiving module 100 outputs a dialog box to inquire the user whether to capture the image. When the user selects a “yes” option, the camera device 20 of the client device 2 captures the image of the user. When the user selects a “no” option, no image is captured.

In step S02, the identification module 101 identifies facial feature data of the user from the image.

In step S03, the creation module 102 stores the identified facial feature data into the storage device 22, creates a blank user log for the user, and relates the identified facial feature data and the user log. FIG. 6 shows an example of a user log of user A. The user log includes columns, such as an attributes column and a reference parameters column. The attributes column records attributes of the user A, such as age, sex, and nationalities, for example. The reference parameters column records parameters about search histories of the user A or similar users. The similar users include users which have the same attributes as the user A, such as, having the same age, the same sex or the nationality as the user A. In one embodiment, the reference parameters column includes a first reference parameters column and a second reference parameter column. The first reference parameters column records the parameters about the search histories of the user A, and the second reference parameter column records the parameters about the search histories of similar users.

In step S04, the analysis module 103 analyzes attributes of the user according to the facial feature data, and storing the attributes into the user log. As mentioned above, the attributes include characteristics such as age, sex, and nationality, for example.

In step S05, the record module 104 obtains one or more web pages which have been browsed by the user, wherein the web pages are obtained from a search result relating to the keyword.

In step S06, the record module 104 analyzes one or more feature values from documents contained in the browsed web pages, records the keyword and the feature values as reference parameters, and stores the reference parameters into the user log. The document contained in the web pages may include graphics, texts, and videos. The feature values may be one or more words or phrases which have high frequencies in the document contained in one web page. In one embodiment, the keyword and the feature values are respectively recorded in a prior keywords column and a feature values column of the first reference parameters column in the user log.

In other embodiments, the method in FIG. 5 may further include the following steps. In step S07, the classification module 108 classifies users based on their keywords input, according to attributes of the users, to obtain similar users. In step S08, the collection module 109 obtains the keywords inputted by the similar users, and obtains one or more web pages relating to the keywords which have been browsed by the similar users, analyzes one or more feature values from documents contained in the browsed web pages, records the keywords and the feature values also as the reference parameters, and stores the reference parameters into the user log. The keywords and the feature values are respectively recorded in a prior keywords column and a feature values column of the second reference parameters column in the user log.

FIG. 7 illustrates a flowchart of one embodiment of the web search optimization method. The method is executed by at least one processor of an electronic device, for example, the control device 11 of the server 1 or the control device 12 of each of the client devices 2. Depending on the embodiment, additional steps in FIG. 7 may be added, others removed, and the ordering of the steps may be changed.

In step S10, the receiving module 100 receives a keyword inputted by a user from one of the client devices 2, and captures an image of the user. As mentioned above, each of the client devices 2 includes a search engine which allows the user to input the keyword to query web pages containing information related to the keyword from the server 1. In one embodiment, the receiving module 100 receives the keyword from the search engine of the client device 2. In one embodiment, the receiving module 100 activates the camera device 20 of the client device 2 to automatically capture the image of the user. In another embodiment, the receiving module 100 outputs a dialog box to inquire of the user whether to capture the image. When the user selects a “yes” option, the camera device 20 of the client device 2 captures the image of the user. When the user selects a “no” option, no image is captured.

In step S11, the identification module 101 identifies facial feature data of the user from the image.

In step S12, the determination module 105 determines if there is facial feature data matched with the identified facial feature data in the storage device 22. Step S13 is implemented when there is no facial feature data matched with the identified facial feature data in the storage device 22. Otherwise, step S14 is implemented when there is facial feature data matched with the identified facial feature data in the storage device 22.

In step S13, the creation module 102 creates a user log for the user. The creation of the user log refers to step S03 to S06 in FIG. 5 are implemented.

In step S14, the rank module 106 obtains the reference parameters from the user log which corresponds to the identified facial feature data.

In step S15, the rank module 106 obtains a searched result relating to the keyword. The searched result can be transmitted from the server 1 through the network 3.

In step S16, the rank module 106 ranks the web pages of the searched result according to the reference parameters. For detailed description of step S16 please refer to FIG. 8 below.

In step S17, the output module 107 outputs the ranked web pages to the client device 2 to the user.

FIG. 8 illustrates a flowchart of detailing S16 in FIG. 7. Depending on the embodiment, additional steps in FIG. 7 may be added, others removed, and the ordering of the steps may be changed.

In step S160, the rank module 106 determines whether the reference parameters include a prior keyword which is similar to the current inputted keyword. Step S161 is implemented when the reference parameters include a prior keyword which is similar to the current inputted keyword. Otherwise, the procedure ends when the reference parameters does not include a prior keyword which is similar to the current inputted keyword.

In step S161, the rank module 106 obtains feature values corresponding to the prior keyword which is similar to the current inputted keyword.

In step S162, the rank module 106 ranks the web pages in the searched result relating to the current inputted keyword according to frequencies of the feature values appearing in the documents contained in the web pages.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A web search optimization method, the method being executed by at least one processor of an electronic device, the method comprising:
receiving a keyword inputted by a user from a client device, and capturing an image of the user;
identifying facial feature data of the user from the image;
determining if there is facial feature data matched with the identified facial feature data in a storage device of the electronic device;
obtaining reference parameters which corresponds to the identified facial feature data when there is facial feature data matched with the identified facial feature data in the storage device of the electronic device;
obtaining a searched result relating to the keyword, and ranking web pages of the searched result according to the reference parameters; and
outputting the ranked web pages to the client device.

2. The method according to claim 1, further comprising:
storing the identified facial feature data into the storage device, creating a user log, and relating the identified facial feature data and the user log;
obtaining one or more web pages which have been browsed by the user, wherein the web pages are from a search result relating to the keyword; and
analyzing one or more feature values from documents contained in the browsed web pages, recording the keyword and the feature values as reference parameters, and storing the reference parameters into the user log.

3. The method according to claim 2, further comprising:
analyzing attributes of the user according to the facial feature data, and storing the attributes into the user log;
classifying all users based on their keywords input according to attributes of the users, to obtain similar users; and
obtaining the keywords inputted by the similar users, obtaining one or more web pages relating to the keywords which have been browsed by the similar users, analyzing one or more feature values from documents contained in the browsed web pages, recording the keywords and the feature values also as the reference parameters, and storing the reference parameters into the user log.

4. The method according to claim 3, wherein the feature values comprise words or phrases which have high frequencies in the documents contained in the web pages.

5. The method according to claim 4, wherein the web pages are ranked according to frequencies of the feature values appearing in the documents contained in the web pages.

6. The method according to claim 3, wherein the attributes comprise age, sex, and nationality.

7. An apparatus that executes a web searching method, the apparatus comprising:
a control device; and
a storage device storing one or more programs which when executed by the control device, causes the control device to:
receive a keyword inputted by a user from a client device, and capture an image of the user;
identify facial feature data of the user from the image;
determine if there is facial feature data matched with the identified facial feature data in a storage device of the electronic device;
obtain reference parameters which corresponds to the identified facial feature data when there is facial feature data matched with the identified facial feature data in the storage device of the electronic device;
obtain a searched result relating to the keyword, and rank web pages of the searched result according to the reference parameters; and
output the ranked web pages to the client device.

8. The apparatus according to claim 7, wherein the control device further:
store the identified facial feature data into the storage device, create a user log, and relate the identified facial feature data and the user log;
obtain one or more web pages which have been browsed by the user, wherein the web pages are from a search result relating to the keyword; and
analyze one or more feature values from documents contained in the browsed web pages, record the keyword and the feature values as reference parameters, and store the reference parameters into the user log.

9. The apparatus according to claim 8, wherein the control device further:
analyze attributes of the user according to the facial feature data, and store the attributes into the user log;
classify all users based on their keywords input according to attributes of the users, to obtain similar users; and
obtain the keywords inputted by the similar users, obtain one or more web pages relating to the keywords which have been browsed by the similar users, analyze one or more feature values from documents contained in the browsed web pages, record the keywords and the feature values also as the reference parameters, and store the reference parameters into the user log.

10. The apparatus according to claim 9, wherein the feature values comprise words or phrases which have high frequencies in the documents contained in the web pages.

11. The apparatus according to claim 10, wherein the web pages are ranked according to frequencies of the feature values appearing in the documents contained in the web pages.

12. The apparatus according to claim 9, wherein the attributes comprise age, sex, and nationality.

13. A non-transitory storage medium having stored thereon instructions that, when executed by a processor of an electronic device, causes the processor to perform a web searching method, wherein the method comprises:
receiving a keyword inputted by a user from a client device, and capturing an image of the user;
identifying facial feature of the user data from the image;
determining if there is facial feature data matched with the identified facial feature data in a storage device of the electronic device;
obtaining reference parameters which corresponds to the identified facial feature data when there is facial feature data matched with the identified facial feature data in the storage device of the electronic device;
obtaining a searched result relating to the keyword, and ranking web pages of the searched result according to the reference parameters; and
outputting the ranked web pages to the client device.

14. The non-transitory storage medium according to claim 13, wherein the method further comprises:
storing the identified facial feature data into the storage device, creating a user log, and relating the identified facial feature data and the user log;
obtaining one or more web pages which have been browsed by the user, wherein the web pages are from a search result relating to the keyword; and
analyzing one or more feature values from documents contained in the browsed web pages, recording the keyword and the feature values as reference parameters, and storing the reference parameters into the user log.

15. The non-transitory storage medium according to claim 14, wherein the method further comprises:
analyzing attributes of the user according to the facial feature data, and storing the attributes into the user log;
classifying all users based on their keywords input according to attributes of the users, to obtain similar users; and
obtaining the keywords inputted by the similar users, obtaining one or more web pages relating to the keywords which have been browsed by the similar users, analyzing one or more feature values from documents contained in the browsed web pages, recording the keywords and the feature values also as the reference parameters, and storing the reference parameters into the user log.

16. The non-transitory storage medium according to claim 15, wherein the feature values comprise words or phrases which have high frequencies in the documents contained in the web pages.

17. The non-transitory storage medium according to claim 16, wherein the web pages are ranked according to frequencies of the feature values appearing in the documents contained in the web pages.

18. The non-transitory storage medium according to claim 15, wherein the attributes comprise age, sex, and nationality.
